(19) United States
(12) Patent Application Publication
(10) Pub. No.: US 2026/0126090 A1
(43) Pub. Date: May 7, 2026

(54) brake disc having ultra-high-speed laser cladded wear-resistant and corrosion-resistant coating on surface and preparation method therefor, and vehicle

(71) Applicant: BGRIMM Advanced Materials Science & Technology Co.,Ltd., Beijing (CN)

(72) Inventors: Ziqiang Pi, Beijing (CN); Kaiping Du, Beijing (CN); Xing Chen, Beijing (CN); Zhaoran Zheng, Beijing (CN); Chen Wang, Beijing (CN); Xin Zhang, Beijing (CN)

(73) Assignee: BGRIMM Advanced Materials Science & Technology Co.,Ltd., Beijing (CN)

(21) Appl. No.: 19/380,885

(22) Filed: Nov. 5, 2025

(30) Foreign Application Priority Data
Nov. 6, 2024 (CN) 202411570943.8

(51) Int. Cl. F16D 65/12; C23C 24/10

(52) U.S. Cl. CPC F16D 65/125; C23C 24/106; F16D 2250/0046

(57) ABSTRACT

The present disclosure relates to the field of brake discs. Provided are a brake disc having a surface ultra-high-speed laser cladded wear-resistant and corrosion-resistant coating and a preparation method thereof, and a vehicle. The preparation method includes: performing pretreatment on a brake disc to obtain a brake disc to be cladded; adjusting an angle of the brake disc to be cladded, such that an included angle ∠1 between a surface to be cladded and an axis of a cladding head and an included angle ∠2 between an edge of the cladding head and the axis of the cladding head satisfy: ∠1+0.5∠2<90°; and sequentially performing ultra-high-speed laser cladding of a bottom layer and ultra-high-speed laser cladding of a hard surface layer on the brake disc to be cladded to obtain the brake disc having the surface ultra-high-speed laser cladded wear-resistant and corrosion-resistant coating. The surface to be cladded is disposed at a certain included angle to the axis of the cladding head, thereby avoiding damages to a cladding head assembly by high-power laser reflection; and during ultra-high-speed laser cladding, a turntable is regulated and controlled in a coordinated manner, such that a rotation speed of the brake disc and a movement speed of the cladding head synchronously vary over time, thereby ensuring that a linear speed and an overlap rate remain uniform during cladding.

### TECHNICAL FIELD

The present disclosure relates to the field of brake discs, and in particular to a rake disc having a surface ultra-high-speed laser cladded wear-resistant and corrosion-resistant coating and a preparation method thereof, and a vehicle.

### BACKGROUND

The particle matter emission from a brake system of a vehicle exhibits a local effect and may cause great harm to humans. Unlike carbon dioxide emission which has a global impact on the atmosphere, particle matter emission generated by the friction between a brake pad and a brake disc during vehicle braking has a local effect, i.e. causing the greatest harm to people and environment near the emission source (for example, a crossroad and a busy road). Studies indicate that the intake of the particles may cause physical harm such as respiratory diseases and cancers, and increase the risk of having the Alzheimer's disease. The Euro 7 standard that is newly issued by the European Union regulates particle matter emission from braking systems for the first time. To comply with this stringent standard, the most fundamental solution is to enhance the wear resistance of brake discs, thereby reducing the particle emission caused by wear at the source.

An ultra-high-speed laser cladding technique is to make powder meet a laser beam above a workpiece so as to be melted, so that the powder is then uniformly deposited on a surface of the workpiece, and solidifies to form a protective coating. The cladding rate can reach 20 m/min to 200 m/min. The coating has relatively high surface quality and usually can be applied only after simple grinding or polishing. The coating is metallurgically bound and has high performance stability. Compared with conventional surface protection techniques, the ultra-high-speed laser cladding technique has irreplaceable application advantages in terms of cost, efficiency and automation, and is particularly suitable for the preparation of a wear-resistant and corrosion-resistant coating on a brake disc.

However, high-power laser reflection must be used during ultra-high-speed laser cladding, which may cause damage to a cladding head assembly; and the coating formed by ultra-high-speed laser cladding has the problems of non-uniformity, poor wear resistance, etc.

### SUMMARY

An objective of the present disclosure is to provide a brake disc having a surface ultra-high-speed laser cladded wear-resistant and corrosion-resistant coating and a preparation method thereof, and a vehicle, so as to solve the above problems.

To achieve the above objective, the first aspect of the present disclosure provides a method for preparing a brake disc having a surface ultra-high-speed laser cladded wear-resistant and corrosion-resistant coating, wherein the method includes:
performing pretreatment on a brake disc to obtain a brake disc to be cladded;
adjusting an angle of the brake disc to be cladded, such that an included angle ∠1 between a surface to be cladded and an axis of a cladding head and an included angle ∠2 between an edge of the cladding head and the axis of the cladding head satisfy:

$$∠ 1 + 0.5 ∠ 2 < 90 ° ;$$

and
sequentially performing the ultra-high-speed laser cladding of a bottom layer and the ultra-high-speed laser cladding of a hard surface layer on the brake disc to be cladded to obtain the brake disc having the surface ultra-high-speed laser cladded wear-resistant and corrosion-resistant coating,
wherein the ultra-high-speed laser cladding of the bottom layer includes: rotating the brake disc to be cladded, and performing the ultra-high-speed laser cladding of the bottom layer from inside to outside to obtain the brake disc having the bottom layer;
the ultra-high-speed laser cladding of the hard surface layer includes: performing, from outside to inside, the ultra-high-speed laser cladding of the hard surface layer on the brake disc having the bottom layer to obtain the brake disc having the surface ultra-high-speed laser cladded wear-resistant and corrosion-resistant coating;
∠1 remains unchanged during the ultra-high-speed laser cladding of the bottom layer and the ultra-high-speed laser cladding of the hard surface layer;
in the ultra-high-speed laser cladding of the bottom layer, an initial rotation speed of the brake disc to be cladded meets:

$${W}_{1} = V \cdot {D}_{1}^{- 1} / π ;$$

in the ultra-high-speed laser cladding of the bottom layer, an initial movement speed of the cladding head meets:

$${M}_{1} = L ( 1 - η ) V \cdot {D}_{1}^{- 1} / π ;$$

during the ultra-high-speed laser cladding of the bottom layer, a rotation speed of the brake disc to be cladded is gradually decreased and meets:

$${W}_{1}^{′} = [ - {D}_{1} + \sqrt{{D}_{1}^{2} + 8 L ( 1 - η ) V {t}_{1} / π} ] / 4 L ( 1 - η ) {t}_{1} ;$$

during the ultra-high-speed laser cladding of the bottom layer, a movement speed of the cladding head is gradually decreased and meets:

$${M}_{1}^{′} = [ - {D}_{1} + \sqrt{{D}_{1}^{2} + 8 L ( 1 - η ) V {t}_{1} / π} ] / 4 {t}_{1} ;$$

in the ultra-high-speed laser cladding of the hard surface layer, an initial rotation speed of the brake disc having the bottom layer meets:

$${W}_{2} = V \cdot {D}_{2}^{- 1} / π ;$$

in the ultra-high-speed laser cladding of the hard surface layer, an initial movement speed of the cladding head meets:

$${M}_{2} = L ( 1 - η ) V \cdot {D}_{2}^{- 1} / π ;$$

during the ultra-high-speed laser cladding of the hard surface layer, a rotation speed of the brake disc having the bottom layer is gradually increased and meets:

$${W}_{2}^{′} = [ {D}_{2} + \sqrt{{D}_{2}^{2} 8 L ( 1 - η ) V {t}_{2} / π} ] / 4 L ( 1 - η ) {t}_{2} ;$$

during the ultra-high-speed laser cladding of the hard surface layer, a movement speed of the cladding head is gradually increased and meets:

$${M}_{2}^{′} = [ {D}_{2} + \sqrt{{D}_{2}^{2} 8 L ( 1 - η ) V {t}_{2} / π} ] / 4 {t}_{2} ;$$

wherein W₁ refers to the initial rotation speed of the brake disc to be cladded in the preparation of the brake disc having the bottom layer, W₁′ refers to a real-time rotation speed during the preparation of the brake disc having the bottom layer, W₂ refers to the initial rotation speed of the brake disc having the bottom layer in preparation of the brake disc having the surface ultra-high-speed laser cladded wear-resistant and corrosion-resistant coating, W₂′ refers to a real-time rotation speed during the preparation of the brake disc having the surface ultra-high-speed laser cladded wear-resistant and corrosion-resistant coating, M₁ refers to the initial movement speed of the cladding head in the ultra-high-speed laser cladding of the bottom layer, M₁′ refers to the movement speed of the cladding head during the ultra-high-speed laser cladding of the bottom layer, M₂ refers to the initial movement speed of the cladding head in the ultra-high-speed laser cladding of the hard surface layer, M₂′ refers to the movement speed of the cladding head during the ultra-high-speed laser cladding of the hard surface layer, V refers to a linear speed, L refers to a laser spot diameter, η refers to an overlap rate, D₁ refers to an inner diameter of the brake disc, D₂ refers to an outer diameter of the brake disc, and t₁ and t₂ respectively refer to a cladding time of the ultra-high-speed laser cladding of the bottom layer or a cladding time of the ultra-high-speed laser cladding of the hard surface layer.

In some embodiments, the pretreatment includes:
removing oil stains from a surface of the brake disc by using alcohol and/or acetone to obtain the brake disc to be cladded.

In some embodiments, raw materials of the bottom layer prepared by the ultra-high-speed laser cladding of the bottom layer include 316L stainless steel.

In some embodiments, raw materials of the hard surface layer prepared by the ultra-high-speed laser cladding of the hard surface layer include an iron-based alloy and hard particles.

In some embodiments, the iron-based alloy, based on a total mass being 100%, includes:
less than 0.02 wt % of C, 16 wt %-18 wt % of Cr, 11 wt %-13 wt % of Ni, 2 wt %-3 wt % of Mo, 0.5 wt %-1 wt % of Si, 0.1 wt %-0.5 wt % of Mn, and Fe as a balance.

In some embodiments, the hard particles include one or more selected from the group consisting of tungsten carbide, titanium carbide, chromium carbide, and silicon carbide.

In some embodiments, the method for preparing the brake disc having the surface ultra-high-speed laser cladded wear-resistant and corrosion-resistant coating meets at least one of the following conditions:
A. a particle size of the iron-based alloy and/or the hard particles is in a range of 15 μm to 53 μm; and
B. a mass content of the hard particles in the hard surface layer is in a range of 20 wt % to 50 wt %.

In some embodiments, the method for preparing the brake disc having the surface ultra-high-speed laser cladded wear-resistant and corrosion-resistant coating meets at least one of the following conditions:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

The second aspect of the present disclosure provides a brake disc having a surface ultra-high-speed laser cladded wear-resistant and corrosion-resistant coating, prepared by the method for preparing the brake disc having the surface ultra-high-speed laser cladded wear-resistant and corrosion-resistant coating.

The third aspect of the present disclosure provides a vehicle, including the brake disc having the surface ultra-high-speed laser cladded wear-resistant and corrosion-resistant coating.

Compared with the prior art, the beneficial effects of some embodiments of the present disclosure include:
according to the method for preparing a brake disc having a surface ultra-high-speed laser cladded wear-resistant and corrosion-resistant coating provided in the present disclosure, first, a surface to be cladded is disposed at a certain included angle to the axis of the cladding head, so as to avoid the damage to a cladding head assembly by high-power laser reflection which is necessary in ultra-high-speed laser cladding; second, during the ultra-high-speed laser cladding, a turntable is regulated and controlled in a coordinated manner, such that the rotation speed of the brake disc to be cladded or the brake disc having the bottom layer, and the movement speed of the cladding head synchronously vary over time, thereby ensuring that both a linear speed and an overlap rate remain uniform during cladding, and thus improving the uniformity of the thickness, structure and performance of the cladded layers; and then, to reduce a deformation amount, different cladding directions are adopted for the two cladded layers (i.e. the bottom layer and the hard surface layer). The cladding of the bottom layer is performed from the inner diameter to the outer diameter of a brake disc to be processed, during which the diameter of the brake disc to be cladded continuously increases. To keep the linear speed V for cladding unchanged, the rotation speed W₁′ of the brake disc to be cladded should continuously decrease, and needs to meet a corresponding equation. Meanwhile, since the rotation speed W₁′ of the brake disc to be cladded continuously decreases, to keep the cladding track overlap rate unchanged, the movement speed M₁′ of the cladding head should also continuously decrease, and needs to meet a corresponding equation. Correspondingly, the cladding of the hard surface layer is performed from the outer diameter to the inner diameter of the brake disc having the bottom layer, during which the diameter of the brake disc having the bottom layer continuously decreases. To maintain the linear speed V for cladding unchanged, the movement speed W₂′ of the brake disc having the bottom layer should continuously increase, and needs to meet another corresponding equation. Meanwhile, since the movement speed of the brake disc having the bottom layer continuously increases, to maintain the cladding track overlap rate unchanged, the movement speed M₂′ of the cladding head should also continuously increase, and needs to meet another corresponding equation.

According to the brake disc having the surface ultra-high-speed laser cladded wear-resistant and corrosion-resistant coating provided in the present disclosure, the preparation efficiency of the wear-resistant and corrosion-resistant coating of the brake disc may reach 7.2 m²/h, which reaches the highest level currently reported abroad. The cladding time for one coating on the brake disc (the outer diameter being 288 mm, and the inner diameter being 135 mm) is within 30 seconds, which significantly improves the production efficiency. The cladding head is at a specific angle to the brake disc, which effectively avoids the damage to an optical assembly of a cladding apparatus by laser reflection. The powder utilization rate reaches 90% or larger, greatly reducing the costs. Cladding parameters are dynamically adjusted, thereby improving the uniformity of the structure of the coating. The bottom layer of a double-layered structure provides great corrosion resistance, and the surface layer has excellent wear resistance, which not only avoids adverse effects on life and property safety from unstable braking performance caused by the corrosion of the brake disc due to rain, snow, humidity or long-term parking, but also reduces the corrosion and wear, greatly prolongs the service life of the brake disc, and reduces solid particle matter emission from a braking system, thereby being of significance in promoting the construction of a green and environmental society.

The vehicle provided in the present disclosure reduces particle matter emission generated by the wear of the brake disc.

### BRIEF DESCRIPTION OF DRAWINGS

To more clearly illustrate technical solutions of embodiments of the present disclosure, the accompanying drawings required to be used in embodiments will be briefly described below. It is to be noted that the accompanying drawings below merely show some embodiments of the present disclosure, and are therefore not to be considered as limiting the scope of the present disclosure.

FIG. 1 is a schematic diagram showing a cladding process in a method for preparing a brake disc having a surface ultra-high-speed laser cladded wear-resistant and corrosion-resistant coating according to an embodiment of the present disclosure;

FIG. 2 is a schematic diagram showing a coating prepared using an existing cladding method;

FIG. 3 shows a macro morphology diagram of the brake disc having the surface ultra-high-speed laser cladded wear-resistant and corrosion-resistant coating prepared in Example 1; and

FIG. 4 is a microstructure diagram showing the brake disc having the surface ultra-high-speed laser cladded wear-resistant and corrosion-resistant coating prepared in Example 1.

### DETAILED DESCRIPTION OF THE EMBODIMENTS

As used herein, the terms “made of . . . ” and “comprise . . . ” have the same meaning. The terms “comprise/comprising”, “include/including”, “have/having”, “contain/containing” or any variations thereof as used herein are intended to cover non-exclusive inclusions. For example, a composition, step, method, product, or device that includes the listed elements is not necessarily limited to those elements only, but may also include other elements not explicitly listed or elements that are inherent to such composition, step, method, product, or device.

The transitional phrase “consisting of . . . ” excludes any element, step, or component that is not specified. When used in a claim, this phrase renders the claim closed, meaning it does not include materials other than those recited, except for conventional related impurities. When the phrase “consisting of . . . ” appears in a clause of the body of the claim, rather than immediately following the subject matter, it limits only the element set forth in that clause; and other elements are not excluded from the claim as a whole.

When an amount, concentration, or other value or parameter is given as either a range, preferred range, or a list of upper preferable values and lower preferable values, this is to be understood as specifically disclosing all ranges formed from any pair of an upper limit value or preferred value of any range and a lower limit value or preferred value of any range, regardless of whether ranges are separately disclosed. For example, when a range of “1 to 5” is disclosed, the described range should be interpreted to include ranges such as “1 to 4”, “1 to 3”, “1 to 2”, “1 to 2 and 4 to 5”, “1 to 3 and 5”, etc. Where a numerical range is recited herein, unless otherwise stated, the range is intended to include the endpoints thereof, and all integers and fractions within the range.

In these embodiments, unless otherwise indicated, the parts and percentages are by mass.

“Part by mass” refers to an elementary unit of measurement that represents a mass ratio relationship among multiple components, for example, 1 part can represent any unit mass, such as 1 g, or 2.689 g. If we say that the parts by mass of component A are a parts, and the parts by mass of component B are b parts, a mass ratio of the component A to the mass of the component B is a:b. Alternatively, it means that the mass of the component A is aK, and the mass of the component B is bK (K is any number, and represents a multiple factor). It should not be misunderstood that differing from mass fraction, the sum of the parts by mass of all components is not limited to 100 parts.

The term “and/or” is used to indicate that one or both of the illustrated situations may possibly occur, for example, A and/or B include (A and B) and (A or B).

The first aspect of the present disclosure provides a method for preparing a brake disc having a surface ultra-high-speed laser cladded wear-resistant and corrosion-resistant coating. The method includes:
performing pretreatment on a brake disc to obtain a brake disc to be cladded; and
adjusting an angle of the brake disc to be cladded, such that an included angle ∠1 between a surface to be cladded and an axis of a cladding head and an included angle ∠2 between an edge of the cladding head and the axis of the cladding head satisfy:

$$∠ 1 + 0.5 ∠ 2 < 90 ° .$$

It should be noted that, in existing practical production, a workpiece is often horizontally placed during laser cladding, such that powder can better converge onto a surface of the workpiece, thereby improving the powder utilization rate. As to ultra-high-speed laser cladding, the laser power is high, and the reflection of laser at the surface of the workpiece is prone to causing damage to a cladding head. Therefore, as shown in FIG. 1, a workpiece is deflected by a certain angle in the present disclosure, so as to reduce the impact of the reflection on the cladding head. Moreover, since the convergence position of the laser and the powder is above the workpiece rather than on the surface of the workpiece during the ultra-high-speed laser cladding, and the powder, after being pre-melted, reaches the surface of the workpiece in a semi-melted state so as to be adhered to the surface of the workpiece, and thus does not significantly affect the powder utilization rate at this deflection angle.

The method also includes: sequentially performing ultra-high-speed laser cladding of a bottom layer and ultra-high-speed laser cladding of a hard surface layer on the brake disc to be cladded to obtain the brake disc having the surface ultra-high-speed laser cladded wear-resistant and corrosion-resistant coating; where
the ultra-high-speed laser cladding of the bottom layer includes: rotating the brake disc to be cladded, and performing the ultra-high-speed laser cladding of the bottom layer from inside to outside to obtain a brake disc having the bottom layer;
the ultra-high-speed laser cladding of the hard surface layer includes: performing, from outside to inside, the ultra-high-speed laser cladding of the hard surface layer on the brake disc having the bottom layer to obtain the brake disc having the surface ultra-high-speed laser cladded wear-resistant and corrosion-resistant coating;
∠1 remains unchanged during the ultra-high-speed laser cladding of the bottom layer and the ultra-high-speed laser cladding of the hard surface layer;
in the ultra-high-speed laser cladding of the bottom layer, an initial rotation speed of the brake disc to be cladded meets:

$${W}_{1} = V \cdot {D}_{1}^{- 1} / π ;$$

in the ultra-high-speed laser cladding of the bottom layer, an initial movement speed of the cladding head meets:

$${M}_{1} = L ( 1 - η ) V \cdot {D}_{1}^{- 1} / π ;$$

during the ultra-high-speed laser cladding of the bottom layer, a rotation speed of the brake disc to be cladded is gradually decreased and meets:

$${W}_{1}^{′} = [ - {D}_{1} + \sqrt{{D}_{1}^{2} + 8 L ( 1 - η ) V {t}_{1} / π} ] / 4 L ( 1 - η ) {t}_{1} ;$$

during the ultra-high-speed laser cladding of the bottom layer, a movement speed of the cladding head is gradually decreased and meets:

$${M}_{1}^{′} = [ - {D}_{1} + \sqrt{{D}_{1}^{2} + 8 L ( 1 - η ) {Vt}_{1} / π} ] / 4 {t}_{1} ;$$

in the ultra-high-speed laser cladding of the hard surface layer, an initial rotation speed of the brake disc having the bottom layer meets:

$${W}_{2} = V \cdot {D}_{2}^{- 1} / π ;$$

in the ultra-high-speed laser cladding of the hard surface layer, an initial movement speed of the cladding head meets:

$${M}_{2} = L ( 1 - η ) V \cdot {D}_{2}^{- 1} / π ;$$

during the ultra-high-speed laser cladding of the hard surface layer, a rotation speed of the brake disc having the bottom layer is gradually increased and meets:

$${W}_{2}^{′} = [ {D}_{2} + \sqrt{{D}_{2}^{2} - 8 L ( 1 - η ) {Vt}_{2} / π} ] / 4 L ( 1 - η ) {t}_{2} ;$$

and
during the ultra-high-speed laser cladding of the hard surface layer, a movement speed of the cladding head is gradually increased and meets:

$${M}_{2}^{′} = [ {D}_{2} + \sqrt{{D}_{2}^{2} - 8 L ( 1 - η ) {Vt}_{2} / π} ] / 4 {t}_{2} .$$

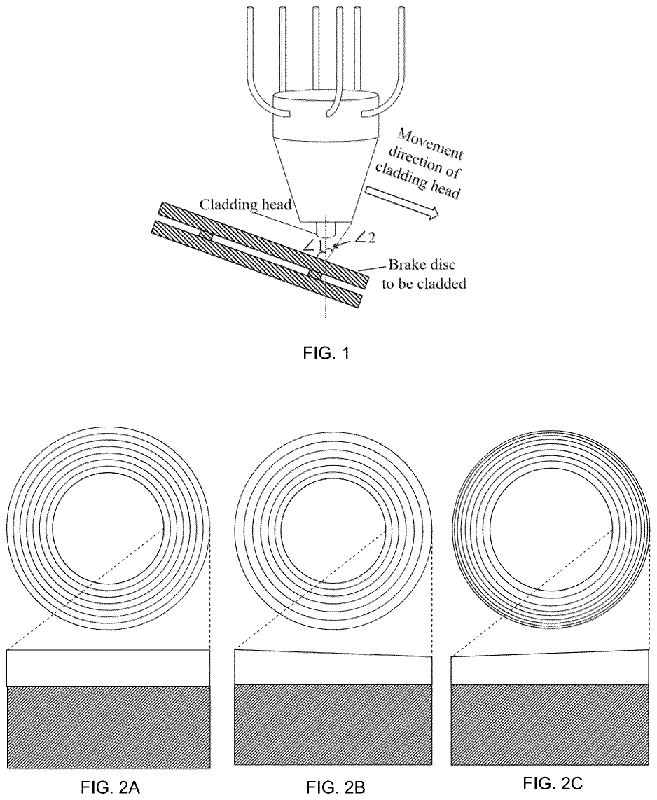

It should be noted that, as shown in FIG. 2, the speed of the cladding head and the rotation speed of the brake disc should be regulated in a coordinated manner during the ultra-high-speed laser cladding. During the preparation of the bottom layer, the cladding head moves from inside to outside, and if there is no regulation, the linear speed may increase, which causes inconsistent thickness and performance of inner parts and outer parts of the coating on the brake disc, resulting in the coating with thicker inside parts and thinner outside parts as shown in the middle diagram of FIG. 2. If the rotation speed of the brake disc is regulated alone without the regulation of the movement speed of the cladding head, although the linear speed can remain consistent, an overlap rate between cladded layers may vary, which may also cause the inconsistent thickness and performance of the inner parts and outer parts of the coating on the brake disc, resulting in coatings with thinner inside parts and thicker outside parts as shown in the right diagram of FIG. 2. For the same reasoning, during the preparation of the hard surface layer, it is also necessary to regulate the rotation speeds of the cladding head and the brake disc in a coordinated manner according to an equation, so as to ensure the consistency and stability of the thickness and performance of the coating.

W₁ refers to the initial rotation speed of the brake disc to be cladded in the preparation of the brake disc having the bottom layer, W₁′ refers to a real-time rotation speed during the preparation of the brake disc having the bottom layer, W₂ refers to the initial rotation speed of the brake disc having the bottom layer in the preparation of the brake disc having the surface ultra-high-speed laser cladded wear-resistant and corrosion-resistant coating, W₂′ refers to a real-time rotation speed during the preparation of the brake disc having the surface ultra-high-speed laser cladded wear-resistant and corrosion-resistant coating, M₁ refers to the initial movement speed of the cladding head in the ultra-high-speed laser cladding of the bottom layer, M₁′ refers to the movement speed of the cladding head during the ultra-high-speed laser cladding of the bottom layer, M₂ refers to the initial movement speed of the cladding head in the ultra-high-speed laser cladding of the hard surface layer, M₂′ refers to the movement speed of the cladding head during the ultra-high-speed laser cladding of the hard surface layer, V refers to a linear speed, L refers to a laser spot diameter, η refers to an overlap rate, D₁ refers to an inner diameter of the brake disc, D₂ refers to an outer diameter of the brake disc, and t₁ and t₂ respectively refer to the cladding time of the ultra-high-speed laser cladding of the bottom layer and the cladding time of the ultra-high-speed laser cladding of the hard surface layer.

It should be noted that, in ultra-high-speed laser cladding, a convergence position of powder and a laser beam is changed from the surface of the workpiece to a position above the workpiece, such that approximately 80% of laser energy directly acts on the powder to pre-melt the powder, the powder is then deposited onto the surface of the workpiece to form a micro melted pool, which rapidly solidifies to form a coating metallurgically bound to the surface of the workpiece. In addition, due to the unique micro melted pool characteristic, the ultra-high-speed laser cladding involves low heat input and has a small heat effect on a substrate. The coating formed has relatively high surface quality and usually can be applied only after simple grinding or polishing. The coating is metallurgically bound and has high performance stability. Compared with conventional surface protection techniques, the ultra-high-speed laser cladding technique has irreplaceable application advantages in terms of cost, efficiency and automation, and is particularly suitable for the preparation of a wear-resistant and corrosion-resistant coating of a brake disc.

In some embodiments, the pretreatment includes:
removing oil stains from a surface of the brake disc by using alcohol and/or acetone to obtain the brake disc to be cladded.

In some embodiments, raw materials of the bottom layer prepared by the ultra-high-speed laser cladding of the bottom layer include 316L stainless steel.

It is to be noted that, under the condition that the raw material of the bottom layer is stainless steel, it functions for compositional transition and also achieves a corrosion resistance effect, reducing the emission of particle matter such as Fe₃O₄ caused by wear of a gray cast iron substrate after be corroded.

In some embodiments, raw materials of the hard surface layer prepared by the ultra-high-speed laser cladding of the hard surface layer include an iron-based alloy and hard particles.

It is to be noted that, under the condition that the raw materials of the hard surface layer include the iron-based alloy and the hard particles, the structure of the iron-based alloy is austenite, which has a face-centered cubic structure. Due to 12 slip systems in the face-centered cubic crystal, there are numerous spatial orientations available during a slip process, facilitating the slip, and thus the austenite exhibits great plasticity. The hard particles have the characteristics of high hardness and high wear resistance. The austenitic iron-based alloy with great plasticity in the coating acts as a binder, securing the hard particles within the coating without inducing cracking. The hard particles enhance the strength and wear resistance of the coating. As a result, the wear resistance of the coating is more than eight times that of the gray cast iron substrate, significantly reducing particle matter emission caused by wear.

In some embodiments, the iron-based alloy, based on a total mass being 100%, includes:
less than 0.02 wt % of C, 16 wt %-18 wt % of Cr, 11 wt %-13 wt % of Ni, 2 wt %-3 wt % of Mo, 0.5 wt %-1 wt % of Si, 0.1 wt %-0.5 wt % of Mn, and Fe as a balance.

In some embodiments, based on the total mass of the iron-based alloy being 100%, the content of C may be 0.001 wt %, 0.01 wt %, 0.015 wt %, or any value less than 0.02 wt %, the content of Cr may be 16 wt %, 17 wt %, 18 wt %, or any value between 16 wt % and 18 wt %, the content of Ni may be 11 wt %, 12 wt %, 13 wt %, or any value between 11 wt % and 13 wt %, the content of Mo may be 2 wt %, 2.5 wt %, 3 wt %, or any value between 2 wt % and 3 wt %, the content of Si may be 0.5 wt %, 0.6 wt %, 0.7 wt %, 0.8 wt %, 0.9 wt %, 1 wt %, or any value between 0.5 wt % and 1 wt %, the content of Mn may be 0.1 wt %, 0.2 wt %, 0.3 wt %, 0.4 wt %, 0.5 wt %, or any value between 0.1 wt % and 0.5 wt %, and the balance is Fe.

It is to be noted that, the iron-based alloy is ultra-low carbon austenitic stainless steel. The austenite has a face-centered cubic structure and great toughness, so as to provide a toughening effect to a composite coating, and also achieve better compatibility with the hard particles (such as tungsten carbide, titanium carbide, chromium carbide, and silicon carbide). Compared with martensitic steel and duplex steel, the martensitic steel, despite its high hardness, undergoes lattice distortion and volumetric expansion during martensitic transformation, which results in great internal stress, and the martensitic steel is prone to crack when excessive ceramic particles are added. In addition, during braking, repeated temperature rises may also induce a tempering transformation in the martensite, which leads to unstable performance. In the duplex stainless steel, the martensite content is approximately 50%, which also leads to similar defects. The remaining part, i.e. a ferrite phase, has good toughness but low strength, thus making it difficult to achieve the effect of anchoring hard particles. Moreover, the ferrite is poor in heat resistance, being prone to softening and deformation under high temperatures. The austenitic phase in the alloy according to the present disclosure achieves better compatibility with hard particles in cladded layers, and the austenite that has great toughness firmly anchors the hard particles in the cladded layers, allowing a hard particle content to reach up to 30 wt % without inducing cracks. The austenitic phase also has higher thermal stability, preventing performance degradation caused by repeated temperature rise during braking.

It is to also be noted that, a relatively high content of Cr and Ni elements promotes the formation of a single austenitic phase in the steel, suppressing the generation of ferrite during cladding, and the two elements can also significantly enhance the corrosion resistance performance of the alloy, preventing the braking performance from being adversely affected by rust formation on a brake disc in complex environments, such as rain and snow. The addition of the Mo element can enhance the high-temperature deformation resistance capability and the creep resistance performance of the steel, so as to facilitate an improvement in the stability of the brake disc during emergency braking. The Mo element can also improve the resistance performance of the steel to pitting and crevice corrosion, further improving the environmental adaptability of the brake disc. However, when the content of Mo exceeds 3.5%, the corrosion rate in an oxidizing medium (such as HNO₃) increases dramatically. Moreover, due to the high price of the Mo element, the content thereof is limited to a maximum of 3.5%. During the ultra-high-speed laser cladding, the Si element has the functions of deoxidization and slag generation, thereby improving the performance of the cladded layer. The Mn element can form stable austenite in combination with N and a certain amount of Ni, and Mn also exhibits a strong affinity with sulfur, so as to form MnS, thereby facilitating the elimination of the adverse effect of residual sulfur in the steel.

In some embodiments, the hard particles include one or more of tungsten carbide, titanium carbide, chromium carbide, and silicon carbide.

It is to be noted that, the hard particles include one or more of tungsten carbide, titanium carbide, chromium carbide, and silicon carbide, and these hard particles all have the characteristics of high hardness and high wear resistance, with a lower price and high price-to-performance ratio.

In some embodiments, the method for preparing the brake disc having the surface ultra-high-speed laser cladded wear-resistant and corrosion-resistant coating meets at least one of the following conditions:
A. A particle size of the iron-based alloy and/or the hard particles is in a range of 15 μm to 53 μm.

In some embodiments, the particle size of the iron-based alloy and/or the hard particles may be 15 μm, 20 μm, 25 μm, 30 μm, 35 μm, 40 μm, 45 μm, 50 μm, 53 μm, or any value between 15 μm and 53 μm.
B. A mass content of the hard particles in the hard surface layer is in a range of 20 wt % to 50 wt %.

In some embodiments, the mass content of the hard particles in the hard surface layer is 20 wt %, 25 wt %, 30 wt %, 35 wt %, 40 wt %, 45 wt %, 50 wt %, or any value between 20 wt % and 50 wt %.

It should be noted that, the mass content of the hard particles in the hard surface layer is in a range of 20 wt % to 50 wt %, when the content of the hard particles is less than 20%, the content is excessively low, and the effect of improving strength and wear resistance is limited; and when the content exceeds 50%, the content of the hard particles is excessively high, and there is insufficient binder phase in the coating, thus being prone to cracking. In addition, during braking, the coating expands under heat. Due to the inconsistent thermal expansion coefficient between the iron-based alloy and the hard particles, hard particles in an excessive amount may lead to thermal cracks.

In some embodiments, the method for preparing the brake disc having the surface ultra-high-speed laser cladded wear-resistant and corrosion-resistant coating meets at least one of the following conditions:
A. the linear speed is in a range of 100 m/min to 200 m/min.

In some embodiments, the linear speed may be 100 m/min, 120 m/min, 140 m/min, 160 m/min, 180 m/min, 200 m/min, or any value between 100 m/min and 200 m/min.

It is to be noted that, the linear speed may reach 100 m/min to 200 m/min, which is significantly increased compared with the linear speed of 0.6 m/min to 1 m/min in traditional laser cladding, thereby significantly improving the cladding efficiency.
B. The laser spot diameter is in a range of 3 mm to 5 mm.

In some embodiments, the laser spot diameter may be 3 mm, 4 mm, 5 mm, or any value between 3 mm and 5 mm.
C. The overlap rate is in a range of 70% to 90%.

In some embodiments, the overlap rate may be 70%, 75%, 80%, 85%, 90%, or any value between 70% and 90%.
D. Each of the ultra-high-speed laser cladding of the bottom layer and the ultra-high-speed laser cladding of the hard surface layer is conducted at a power of 6000 W to 12000 W.

In some embodiments, each of the ultra-high-speed laser cladding of the bottom layer and the ultra-high-speed laser cladding of the hard surface layer is conducted at a power of 6000 W, 7000 W, 8000 W, 9000 W, 10000 W, 11000 W, 12000 W, or any value between 6000 W and 12000 W.
E. A powder feed rate of the cladding head is in a range of 2 g/s to 5 g/s.

In some embodiments, the powder feed rate of the cladding head may be 2 g/s, 3 g/s, 4 g/s, 5 g/s, or any value between 2 g/s and 5 g/s.

The second aspect of the present disclosure provides a brake disc having a surface ultra-high-speed laser cladded wear-resistant and corrosion-resistant coating, which is prepared by the method for preparing the brake disc having the surface ultra-high-speed laser cladded wear-resistant and corrosion-resistant coating.

The third aspect of the present disclosure provides a vehicle, including the brake disc having the surface ultra-high-speed laser cladded wear-resistant and corrosion-resistant coating.

The embodiments of the present disclosure will be described in detail below in conjunction with specific examples. However, those skilled in the art will understand that the following examples merely serve to illustrate the present disclosure and should not be construed as limiting the scope of the present disclosure. If no specific conditions are indicated in the examples, conventional conditions or the conditions suggested by the manufacturer shall be followed. Any reagents or instruments used, without indicated manufactures, are conventional products that are commercially available.

### Example 1

A first aspect of this example provides a method for preparing a brake disc having a surface ultra-high-speed laser cladded wear-resistant and corrosion-resistant coating. The method was composed of/consisted of:
S1: the pretreatment of a surface of a brake disc: oil stains were removed from the surface of the brake disc by using alcohol or acetone to obtain a brake disc to be cladded;
S2: the preparation of iron-based composite powder for the ultra-high-speed laser cladding of a hard surface layer: 70 wt % of iron-based alloy and 30 wt % of hard-particle TiC powder were mixed in a powder mixer for 120 minutes, and after uniformity was achieved, a resulting mixture was dried at 80° C. for 2 hours to obtain the iron-based composite powder for the ultra-high-speed laser cladding of the hard surface layer, where the iron-based alloy powder consisted of: 0.01 wt % of C, 16.8 wt % of Cr, 12.1 wt % of Ni, 2.6 wt % of Mo, 0.8 wt % of S1, 0.3 wt % of Mn, and Fe as a balance, and the iron-based alloy powder and the TiC powder each had a particle size of 15 μm to 53 μm;
S3: the adjustment of included angles: an angle of the brake disc to be cladded was adjusted, such that the included angle ∠1 between a surface to be cladded and the axis of a cladding head and the included angle ∠2 between the edge of the cladding head and the axis of the cladding head satisfied: ∠1+0.5∠2<90°; and
S4, the ultra-high-speed laser cladding of a bottom layer and the ultra-high-speed laser cladding of a hard surface layer were sequentially performed on the brake disc to be cladded to obtain the brake disc having the surface ultra-high-speed laser cladded wear-resistant and corrosion-resistant coating.

The ultra-high-speed laser cladding of the bottom layer was composed of/consisted of: rotating the brake disc to be cladded, and performing the ultra-high-speed laser cladding of the bottom layer from inside to outside to obtain a brake disc having the bottom layer. An initial rotation speed of the brake disc to be cladded at the beginning met W₁=V·D₁⁻¹/π, and W₁ was calculated to be 353.68 r/min. An initial movement speed of the cladding head met M₁=L(1−η)V·D₁⁻¹/π, and M₁ was calculated as 0.2829 m/min. During the ultra-high-speed laser cladding of the bottom layer, the rotation speed of the brake disc to be cladded was gradually decreased and met

$${W}_{1}^{′} = [ - {D}_{1} + \sqrt{{D}_{1}^{2} + 8 L ( 1 - η ) {Vt}_{1} / π} ] / 4 L ( 1 - η ) {t}_{1} ,$$

and parameters were substituted to obtain an equation: W₁′=[−0.135+\sqrt{0.018225+0.3056t₁} ]/0.0032t₁; and the movement speed of the cladding head was gradually decreased and met

$${M}_{1}^{′} = [ - {D}_{1} + \sqrt{{D}_{1}^{2} + 8 L ( 1 - η ) {Vt}_{1} / π} ] / 4 {t}_{1} ,$$

and parameters were substituted to obtain an equation:

$${M}_{1}^{′} = [ - 0.135 + \sqrt{0.018225 + 0.3056 {t}_{1}} ] / 4 {t}_{1} .$$

The ultra-high-speed laser cladding of the hard surface layer was composed of/consisted of: performing, from outside to inside, the ultra-high-speed laser cladding of the hard surface layer on the brake disc having the bottom layer to obtain the brake disc having the surface ultra-high-speed laser cladded wear-resistant and corrosion-resistant coating. An initial rotation speed of the brake disc having the bottom layer at the beginning met W₂=V·D₂⁻¹/π, and W₂ was calculated as 165.79 r/min; and an initial movement speed of the cladding head met M₂=L(1−η)V·D₂⁻¹/π, and M₂ was calculated as 0.1326 m/min. During the ultra-high-speed laser cladding of the hard surface layer, the rotation speed of the brake disc having the bottom layer was gradually increased and met

$${W}_{2}^{′} = [ {D}_{2} + \sqrt{{D}_{2}^{2} - 8 L ( 1 - η ) {Vt}_{2} / π} ] / 4 L ( 1 - η ) {t}_{2} ,$$

and parameters were substituted to obtain an equation:

$${W}_{2}^{′} = [ 0.288 + \sqrt{0.082944 - 0.3056 {t}_{2}} ] / 0.0032 {t}_{2} ;$$

and the movement speed of the cladding head was gradually increased and met

$${M}_{2}^{′} = [ {D}_{2} + \sqrt{{D}_{2}^{2} - 8 L ( 1 - η ) {Vt}_{2} / π} ] / 4 {t}_{2} ,$$

and parameters were substituted to obtain an equation:

$${M}_{2}^{′} = [ 0.288 + \sqrt{0.082944 - 0.3056 {t}_{2}} ] / 4 {t}_{2} .$$

Process parameters of ultra-high-speed laser cladding were as follows: an inner diameter D₁ of the brake disc was 0.135 μm, an outer diameter D₂ of the brake disc was 0.288 μm, a linear speed V was 150 m/min, a laser spot diameter L was 4 mm, an overlap rate η was 80%, the ultra-high-speed laser cladding was conducted at a power of 9000 W, and a powder feed rate of the cladding head was 3.5 g/s.

A second aspect of the present disclosure provides a brake disc having a surface ultra-high-speed laser cladded wear-resistant and corrosion-resistant coating, which was prepared by the above method.

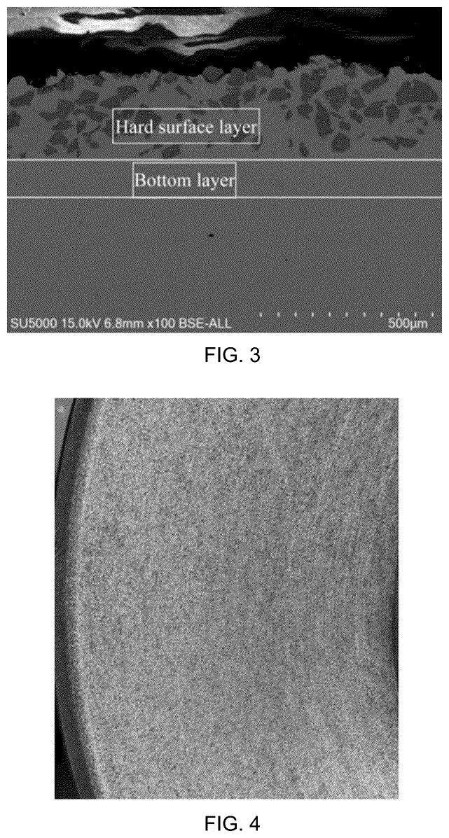

FIG. 3 shows a macro morphology of the brake disc having the surface ultra-high-speed laser cladded wear-resistant and corrosion-resistant coating.

FIG. 4 shows a microstructure of the brake disc having the surface ultra-high-speed laser cladded wear-resistant and corrosion-resistant coating.

Upon friction and wear test, a wear resistance test result of the brake disc having the surface ultra-high-speed laser cladded wear-resistant and corrosion-resistant coating showed that a wear rate was 2.75×10⁻⁶ mm³/N·m, a wear resistance test result of a brake disc showed that a wear rate was 3.03×10⁻⁵ mm³/N·m, and the wear resistance of the brake disc having the surface ultra-high-speed laser cladded wear-resistant and corrosion-resistant coating was 11 times the wear resistance of this brake disc.

### Example 2

A first aspect of this example provides a method for preparing a brake disc having a surface ultra-high-speed laser cladded wear-resistant and corrosion-resistant coating. The method was composed of/consisted of:
S1: the pretreatment of a surface of a brake disc: was used to remove oil stains were removed from the surface of the brake disc by using alcohol or acetone to obtain a brake disc to be cladded;
S2: the preparation of iron-based composite powder for the ultra-high-speed laser cladding of a hard surface layer: 70 wt % of iron-based alloy and 20 wt % of hard-particle TiC powder were mixed in a powder mixer for 120 minutes, and after uniformity was achieved, a resulting mixture was dried at 80° C. for 2 hours to obtain the iron-based composite powder for the ultra-high-speed laser cladding of the hard surface layer, where the iron-based alloy powder consisted of: 0.01 wt % of C, 16.8 wt % of Cr, 12.1 wt % of Ni, 2.6 wt % of Mo, 0.8 wt % of S1, 0.3 wt % of Mn, and Fe as a balance, and the iron-based alloy powder and the TiC powder each had a particle size of 15 μm to 53 μm;
S3: the adjustment of included angles: an angle of the brake disc to be cladded was adjusted, such that the included angle ∠1 between a surface to be cladded and the axis of a cladding head and the included angle ∠2 between the edge of the cladding head and the axis of the cladding head satisfied: ∠1+0.5∠2<90°; and
S4: the ultra-high-speed laser cladding of a bottom layer and the ultra-high-speed laser cladding of a hard surface layer were sequentially performed on the brake disc to be cladded to obtain the brake disc having the surface ultra-high-speed laser cladded wear-resistant and corrosion-resistant coating.

The ultra-high-speed laser cladding of the bottom layer was composed of/consisted of: rotating the brake disc to be cladded, and performing the ultra-high-speed laser cladding of the bottom layer from inside to outside to obtain a brake disc having the bottom layer. An initial rotation speed of the brake disc to be cladded at the beginning met W₁=V·D₁⁻¹/π, and W₁ was calculated to be 353.68 r/min; and an initial movement speed of the cladding head met M₁=L(1−η)V·D₁⁻¹/π, and M₁ was calculated as 0.2829 m/min. During the ultra-high-speed laser cladding of the bottom layer, the rotation speed of the brake disc to be cladded was gradually decreased and met

$${W}_{1}^{′} = [ - {D}_{1} + \sqrt{{D}_{1}^{2} + 8 L ( 1 - η ) {Vt}_{1} / π} ] / 4 L ( 1 - η ) {t}_{1} ,$$

and parameters were substituted to obtain an equation:

$${W}_{1}^{′} = [ - 0.135 + \sqrt{0.018225 + 0.0051 {t}_{1}} ] / 0.0032 {t}_{1} ;$$

and the movement speed of the cladding head was gradually decreased and met

$${M}_{1}^{′} = [ - {D}_{1} + \sqrt{{D}_{1}^{2} + 8 L ( 1 - η ) {Vt}_{1} / π} ] / 4 {t}_{1} ,$$

and parameters were substituted to obtain an equation:

$${M}_{1}^{′} = [ - 0.135 + \sqrt{0.018225 + 0.3056 {t}_{1}} ] / 4 {t}_{1} .$$

The ultra-high-speed laser cladding of the hard surface layer was composed of/consisted of: performing, from outside to inside, the ultra-high-speed laser cladding of the hard surface layer on the brake disc having the bottom layer to obtain the brake disc having the surface ultra-high-speed laser cladded wear-resistant and corrosion-resistant coating. An initial rotation speed of the brake disc having the bottom layer at the beginning met W₂=V·D₂¹/π, and W₂ was calculated as 165.79 r/min; and an initial movement speed of the cladding head met M₂=L(1−η)V·D₂¹/π, and M₂ was calculated as 0.1326 m/min. During the ultra-high-speed laser cladding of the hard surface layer, the rotation speed of the brake disc having the bottom layer was gradually increased and met

$${W}_{2}^{′} = [ {D}_{2} + \sqrt{{D}_{2}^{2} - 8 L ( 1 - η ) {Vt}_{2} / π} ] / 4 L ( 1 - η ) {t}_{2} ,$$

and parameters were substituted to obtain an equation:

$${W}_{2}^{′} = [ 0.288 + \sqrt{0.082944 - 0.3056 {t}_{2}} ] / 0.0032 {t}_{2} ;$$

and the movement speed of the cladding head was gradually increased and met

$${M}_{2}^{′} = [ {D}_{2} + \sqrt{{D}_{2}^{2} - 8 L ( 1 - η ) {Vt}_{2} / π} ] / 4 {t}_{2} ,$$

and parameters were substituted to obtain an equation:

$${M}_{2}^{′} = [ 0.288 + \sqrt{0.082944 - 0.3056 {t}_{2}} ] / 4 {t}_{2} .$$

Process parameters of ultra-high-speed laser cladding were as follows: an inner diameter D₁ of the brake disc was 0.135 μm, an outer diameter D₂ of the brake disc was 0.288 μm, a linear speed V was 150 m/min, a laser spot diameter L was 4 mm, an overlap rate η was 80%, the ultra-high-speed laser cladding was conducted at a power of 9200 W, and a powder feed rate of the cladding head was 3.6 g/s.

Upon friction and wear test, a wear resistance test result of the brake disc having the surface ultra-high-speed laser cladded wear-resistant and corrosion-resistant coating showed that a wear rate was 3.80×10⁻⁶ mm³/N·m, a wear resistance test result of a brake disc showed that a wear rate was 3.03×10⁻⁵ mm³/N·m, and the wear resistance of the brake disc having the surface ultra-high-speed laser cladded wear-resistant and corrosion-resistant coating was 8 times the wear resistance of this brake disc.

### Example 3

A first aspect of this example provides a method for preparing a brake disc having a surface ultra-high-speed laser cladded wear-resistant and corrosion-resistant coating. The method was composed of/consisted of:
S1: the pretreatment of a surface of a brake disc: oil stains were removed from the surface of the brake disc by using alcohol or acetone to obtain a brake disc to be cladded;
S2: the preparation of iron-based composite powder for the ultra-high-speed laser cladding of a hard surface layer: 70 wt % of iron-based alloy and 50 wt % of hard-particle TiC powder were mixed in a powder mixer for 120 minutes, and after uniformity was achieved, a resulting mixture was dried at 80° C. for 2 hours to obtain the iron-based composite powder for the ultra-high-speed laser cladding of the hard surface layer, where the iron-based alloy powder consisted of: 0.01 wt % of C, 16.8 wt % of Cr, 12.1 wt % of Ni, 2.6 wt % of Mo, 0.8 wt % of S1, 0.3 wt % of Mn, and Fe as a balance, and the iron-based alloy powder and the TiC powder each had a particle size of 15 μm to 53 μm;
S3: the adjustment of included angles: an angle of the brake disc to be cladded was adjusted, such that the included angle ∠1 between a surface to be cladded and the axis of a cladding head and the included angle ∠2 between the edge of the cladding head and the axis of the cladding head satisfied: ∠1+0.5∠2<90°; and
S4: the ultra-high-speed laser cladding of a bottom layer and the ultra-high-speed laser cladding of a hard surface layer were sequentially performed on the brake disc to be cladded to obtain the brake disc having the surface ultra-high-speed laser cladded wear-resistant and corrosion-resistant coating.

The ultra-high-speed laser cladding of the bottom layer was composed of/consisted of: rotating the brake disc to be cladded, and performing the ultra-high-speed laser cladding of the bottom layer from inside to outside to obtain a brake disc having the bottom layer. An initial rotation speed of the brake disc to be cladded at the beginning met W₁=V·D₁⁻¹/π, and W₁ was calculated to be 353.68 r/min; and an initial movement speed of the cladding head met M₁=L(1−η)V·D₁⁻¹/π, and M₁ was calculated as 0.2829 m/min. During the ultra-high-speed laser cladding of the bottom layer, the rotation speed of the brake disc to be cladded was gradually decreased and met

$${W}_{1}^{′} = [ - {D}_{1} + \sqrt{{D}_{1}^{2} + 8 L ( 1 - η ) {Vt}_{1} / π} ] / 4 L ( 1 - η ) {t}_{1} ,$$

and parameters were substituted to obtain an equation:

$${W}_{1}^{′} = [ - 0.135 + \sqrt{0.018225 + 0.3056 {t}_{1}} ] / 0.0032 {t}_{1} ;$$

and the movement speed of the cladding head was gradually decreased and met

$${M}_{1}^{′} = [ - {D}_{1} + \sqrt{{D}_{1}^{2} + 8 L ( 1 - η ) {Vt}_{1} / π} ] / 4 {t}_{1} ,$$

and parameters were substituted to obtain an equation:

$${M}_{1}^{′} = [ - 0.135 + \sqrt{0.018225 + 0.3056 {t}_{1}} ] / 4 {t}_{1} .$$

The ultra-high-speed laser cladding of the hard surface layer was composed of/consisted of: performing, from outside to inside, the ultra-high-speed laser cladding of the hard surface layer on the brake disc having the bottom layer to obtain the brake disc having the surface ultra-high-speed laser cladded wear-resistant and corrosion-resistant coating. An initial rotation speed of the brake disc having the bottom layer at the beginning met W₂=V·D₂¹/π, and W₂ was calculated as 165.79 r/min; and an initial movement speed of the cladding head met M₂=L(1−η)V·D₂¹/π, and M₂ was calculated as 0.1326 m/min. During the ultra-high-speed laser cladding of the hard surface layer, the rotation speed of the brake disc having the bottom layer was gradually increased and met

$${W}_{2}^{′} = [ {D}_{2} + \sqrt{{D}_{2}^{2} - 8 L ( 1 - η ) {Vt}_{2} / π} ] / 4 L ( 1 - η ) {t}_{2} ,$$

and parameters were substituted to obtain an equation:

$${W}_{2}^{′} = [ 0.288 + \sqrt{0.082944 - 0.3056 {t}_{2}} ] / 0.0032 {t}_{2} ;$$

and the movement speed of the cladding head was gradually increased and met

$${M}_{2}^{′} = [ {D}_{2} + \sqrt{{D}_{2}^{2} - 8 L ( 1 - η ) {Vt}_{2} / π} ] / 4 {t}_{2} ,$$

and parameters were substituted to obtain an equation:

$${M}_{2}^{′} = [ 0.288 + \sqrt{0.082944 - 0.3056 {t}_{2}} ] / 4 {t}_{2} .$$

Process parameters of ultra-high-speed laser cladding were as follows: an inner diameter D₁ of the brake disc was 0.135 μm, an outer diameter D₂ of the brake disc was 0.288 μm, a linear speed V was 150 m/min, a laser spot diameter L was 4 mm, an overlap rate η was 80%, the ultra-high-speed laser cladding was conducted at a power of 8600 W, and a powder feed rate of the cladding head was 3.3 g/s.

Upon friction and wear test, a wear resistance test result of the brake disc having the surface ultra-high-speed laser cladded wear-resistant and corrosion-resistant coating showed that a wear rate was 2.92×10⁻⁶ mm³/N·m, a wear resistance test result of a brake disc showed that a wear rate was 3.03×10⁻⁵ mm³/N·m, and the wear resistance of the brake disc having the surface ultra-high-speed laser cladded wear-resistant and corrosion-resistant coating was 10.4 times the wear resistance of this brake disc.

### Comparative Example 1

This comparative example provided a method for preparing a brake disc having an ultra-high-speed laser clad coating on a surface, which differed from Example 1 in that: the adjustment of the included angles at step S3 in Example 1 was not performed in this comparative example, resulting in that a surface to be cladded was perpendicular to a cladding head in this comparative example.

Upon friction and wear test, the wear resistance of the brake disc having the ultra-high-speed laser clad coating on the surface prepared in this comparative example was not significantly affected, but apparatuses may be damaged.

### Comparative Example 2

This comparative example provided a method for preparing a brake disc having an ultra-high-speed laser clad coating on a surface, which differed from Example 1 in that:
in the ultra-high-speed laser cladding of the bottom layer, the initial rotation speed of the brake disc to be cladded did not meet:

$${W}_{1} = V \cdot {{D}_{1}}^{- 1} / π , actually {W}_{1} = 400 r / min .$$

Upon friction and wear test, a wear resistance test result of the brake disc having the ultra-high-speed laser clad coating on the surface, prepared in this comparative example, showed that a wear rate was 4.46×10⁻⁶ mm³/N·m, and the wear resistance of the brake disc having the surface ultra-high-speed laser cladded wear-resistant and corrosion-resistant coating was 6.8 times the wear resistance of this brake disc.

### Comparative Example 3

This comparative example provided a method for preparing a brake disc having an ultra-high-speed laser clad coating on a surface, which differed from Example 1 in that: in the ultra-high-speed laser cladding of the bottom layer, the initial movement speed of the cladding head did not meet:

$${M}_{1} = L ( 1 - η ) {V}_{2} \cdot {{D}_{1}}^{- 1} / π , actually {M}_{1} = 0.35 m / min .$$

Upon friction and wear test, a wear resistance test result of the brake disc having the ultra-high-speed laser clad coating on the surface prepared in this comparative example showed that a wear rate was 7.73×10⁻⁶ mm³/N·m, and the wear resistance of the brake disc having the surface ultra-high-speed laser cladded wear-resistant and corrosion-resistant coating was 3.9 times the wear resistance of this brake disc.

### Comparative Example 4

This comparative example provided a method for preparing a brake disc having an ultra-high-speed laser clad coating on a surface, which differed from Example 1 in that: during the ultra-high-speed laser cladding of the bottom layer, the rotation speed of the brake disc to be cladded did not meet:

$${W}_{1}^{′} = [ - {D}_{1} + \sqrt{{D}_{1}^{2} + 8 L ( 1 - η ) V {t}_{1} / π} ] / 4 L ( 1 - η ) {t}_{1} .$$

Upon friction and wear test, a wear resistance test result of the brake disc having the ultra-high-speed laser clad coating on the surface prepared in this comparative example showed that the performance of the coating was not uniform, where the wear rate of the coating close to the center was 4.81×10⁻⁶ mm³/N·m, and the wear resistance of this part of the brake disc having the surface ultra-high-speed laser cladded wear-resistant and corrosion-resistant coating was 6.3 times of the brake disc; and the wear rate of the coating close to the periphery was 6.31×10⁻⁶ mm³/N·m, and the wear resistance of this part of the brake disc having the surface ultra-high-speed laser cladded wear-resistant and corrosion-resistant coating was 4.8 times of the brake disc.

### Comparative Example 5

This comparative example provided a method for preparing a brake disc having an ultra-high-speed laser clad coating on a surface, which differed from Example 1 in that: during the ultra-high-speed laser cladding of the bottom layer, the movement speed of the cladding head did not meet:

$${M}_{1}^{′} = [ - {D}_{1} + \sqrt{{D}_{1}^{2} + 8 L ( 1 - η ) Vt / π} ] / 4 t .$$

Upon friction and wear test, a wear resistance test result of the brake disc having the ultra-high-speed laser clad coating on the surface prepared in this comparative example showed that the performance of the coating was not uniform, where the wear rate of the coating close to the center was 4.97×10⁻⁶ mm³/N·m, and the wear resistance of this part of the brake disc having the surface ultra-high-speed laser cladded wear-resistant and corrosion-resistant coating was 6.1 times of the brake disc; and the wear rate of the coating close to the periphery was 7.21×10⁻⁶ mm³/N·m, and the wear resistance of this part of the brake disc having the surface ultra-high-speed laser cladded wear-resistant and corrosion-resistant coating was 4.2 times of the brake disc.

### Comparative Example 6

This comparative example provided a method for preparing a brake disc having an ultra-high-speed laser clad coating on a surface, which differed from Example 1 in that: in the ultra-high-speed laser cladding of the hard surface layer, the initial rotation speed of the brake disc having the bottom layer did not meet:

$$\begin{matrix}{W}_{2} = {V}_{3} \cdot {D}_{2}^{- 1} / π , \\ actually \\ {W}_{2} = 120 r / min .\end{matrix}$$

Upon friction and wear test, a wear resistance test result of the brake disc having the ultra-high-speed laser clad coating on the surface prepared in this comparative example showed that a wear rate was 5.32×10⁻⁶ mm³/N·m, and the wear resistance of the brake disc having the surface ultra-high-speed laser cladded wear-resistant and corrosion-resistant coating was 5.7 times the wear resistance of the brake disc.

### Comparative Example 7

This comparative example provided a method for preparing a brake disc having an ultra-high-speed laser clad coating on a surface, which differed from Example 1 in that: in the ultra-high-speed laser cladding of the hard surface layer, the initial movement speed of the cladding head did not meet:

$$\begin{matrix}{M}_{2} = L ( 1 - η ) {V}_{4} \cdot {D}_{2}^{- 1} / π , \\ actually \\ {M}_{2} = 0.1 m / min .\end{matrix}$$

Upon friction and wear test, a wear resistance test result of the brake disc having the ultra-high-speed laser clad coating on the surface prepared in this comparative example showed that a wear rate was 5.94×10⁻⁶ mm³/N·m, and the wear resistance of the brake disc having the surface ultra-high-speed laser cladded wear-resistant and corrosion-resistant coating was 5.1 times the wear resistance of the brake disc.

### Comparative Example 8

This comparative example provided a method for preparing a brake disc having an ultra-high-speed laser clad coating on a surface, which differed from Example 1 in that: during the ultra-high-speed laser cladding of the hard surface layer, the rotation speed of the brake disc having the bottom layer did not meet:

$${W}_{2}^{′} = [ {D}_{2} + \sqrt{{D}_{2}^{2} - 8 L ( 1 - η ) V {t}_{2} / π} ] / 4 L ( 1 - η ) {t}_{2} .$$

Upon friction and wear test, a wear resistance test result of the brake disc having the ultra-high-speed laser clad coating on the surface prepared in this comparative example showed that the performance of the coating was not uniform, where the wear rate of the coating close to the center was 5.51×10⁻⁶ mm³/N·m, and the wear resistance of this part of the brake disc having the surface ultra-high-speed laser cladded wear-resistant and corrosion-resistant coating was 5.5 times of the brake disc; and the wear rate of the coating close to the periphery was 4.52×10⁻⁶ mm³/N·m, and the wear resistance of the this part of brake disc having the surface ultra-high-speed laser cladded wear-resistant and corrosion-resistant coating was 6.7 times of the brake disc.

### Comparative Example 9

This comparative example provided a method for preparing a brake disc having an ultra-high-speed laser clad coating on a surface, which differed from Example 1 in that: during the ultra-high-speed laser cladding of the hard surface layer, the movement speed of the cladding head did not meet:

$${M}_{2}^{′} = [ {D}_{2} + \sqrt{{D}_{2}^{2} 8 L ( 1 - η ) V {t}_{2} / π} ] / 4 {t}_{2} .$$

Upon friction and wear test, a wear resistance test result of the brake disc having the ultra-high-speed laser clad coating on the surface prepared in this comparative example showed that the performance of the coating was not uniform, where the wear rate of the coating close to the center was 5.22×10⁻⁶ mm³/N·m, and the wear resistance of this part of the brake disc having the surface ultra-high-speed laser cladded wear-resistant and corrosion-resistant coating was 5.8 times of the brake disc; and the wear rate of the coating close to the periphery was 4.27×10⁻⁶ mm³/N·m, and the wear resistance of this part of the brake disc having the surface ultra-high-speed laser cladded wear-resistant and corrosion-resistant coating was 7.1 times of the brake disc.

### Comparative Example 10

This comparative example provided a method for preparing a brake disc having an ultra-high-speed laser clad coating on a surface, which differed from Example 1 in that: only the iron-based alloy was used as the raw material for the preparation of the hard surface layer.

Upon friction and wear test, a wear resistance test result of the brake disc having the ultra-high-speed laser clad coating on the surface prepared in this comparative example showed that a wear rate was 1.59×10−5 mm³/N·m, and the wear resistance of the brake disc having the surface ultra-high-speed laser cladded wear-resistant and corrosion-resistant coating was 1.9 times the wear resistance of the brake disc.

### Comparative Example 11

This comparative example provided a method for preparing a brake disc having an ultra-high-speed laser clad coating on a surface, which differed from Example 1 in that: only hard particles were used as the raw material for the preparation of the hard surface layer.

Upon friction and wear test, a wear resistance test result of the brake disc having the ultra-high-speed laser clad coating on the surface prepared in this comparative example showed that cladding and forming were not successfully achieved by using the hard particles alone.

### Comparative Example 12

This comparative example provided a method for preparing a brake disc having an ultra-high-speed laser clad coating on a surface, which differed from Example 1 in that: there were 55 wt % of hard particles in the raw materials for the preparation of the hard surface layer.

Upon friction and wear test, a wear resistance test result of the brake disc having ultra-high-speed laser clad coating on the surface prepared in this comparative example showed that macrocracks existed in the hard surface layer, and a cladded layer cannot be used.

### Comparative Example 13

This comparative example provided a method for preparing a brake disc having an ultra-high-speed laser clad coating on a surface, which differed from Example 1 in that: an iron-based alloy in this comparative example, based on a total mass being 100%, consisted of: 0.05 wt % of C, 15 wt % of Cr, 10 wt % of Ni, 5 wt % of Mo, 2 wt % of S1, 0.5 wt % of Mn, and Fe as a balance.

Upon friction and wear test, a wear resistance test result of the brake disc having ultra-high-speed laser clad coating on the surface prepared in this comparative example showed that microcracks existed in a cladded layer and the cladded layer thus cannot be used.

The friction and wear test involved wear caused by reciprocating friction, where the contact manner was flat on flat, SiN balls were used as a friction pair with a diameter of 7.938 mm, the load was 120 N, the time was 30 min, and the reciprocating rate of a steel ball was 10 mm/s.

It can be seen from the above examples and comparative examples that the cladding at a certain angle in the present disclosure can protect an optical assembly of an apparatus from being damaged on the basis of ensuring the performance of a cladded layer, a double-layered structure composed of a bottom layer and a hard surface layer can achieve the effects of corrosion resistance and wear resistance, and by means of the dynamic coordinated regulation of a rotation speed and a movement speed of a cladding head, uniform performance of the cladded layer can be achieved, so as to ensure the performance stability of a brake disc. The wear resistance of the brake disc after cladding can reach 11 times that that of the brake disc free of cladding.

It is to be finally noted that the above examples are merely intended to illustrate the technical solutions of the present disclosure, but not for limiting same. Although the present disclosure is described in detail with reference to the foregoing embodiments, those of ordinary skills in the art should understand that they may still make modifications to the technical solutions described in the foregoing embodiments or make equivalent replacements to some or all technical features thereof. The modifications or replacements should not cause the essence of corresponding technical solutions to depart from the scope of the technical solutions of the embodiments of the present disclosure.

In addition, those skilled in the art can understand that, although some embodiments described herein include some of the features contained in other embodiments but not all the others, combinations of features from different embodiments are intended to fall within the scope of the present disclosure and are considered to form further embodiments. For example, any of the claimed embodiments in the preceding claims may be utilized in any combination. The disclosure of the information in the background section is only for the purpose of improving the understanding of the general background of the present disclosure and is not necessarily to be taken as an acknowledgment or a suggestion in any way that this information constitutes a prior art that is already well known to those skilled in the art.

What is claimed is:

1. A method for preparing a brake disc having a surface ultra-high-speed laser cladded wear-resistant and corrosion-resistant coating, wherein the method comprises:
performing pretreatment on a brake disc to obtain a brake disc to be cladded; and
adjusting an angle of the brake disc to be cladded, such that an included angle ∠1 between a surface to be cladded and an axis of a cladding head and an included angle ∠2 between an edge of the cladding head and the axis of the cladding head satisfy:
$$∠ 1 + 0.5 ∠ 2 < 90 ° ;$$
and
sequentially performing ultra-high-speed laser cladding of a bottom layer and ultra-high-speed laser cladding of a hard surface layer on the brake disc to be cladded to obtain the brake disc having the surface ultra-high-speed laser cladded wear-resistant and corrosion-resistant coating,
wherein the ultra-high-speed laser cladding of the bottom layer comprises: rotating the brake disc to be cladded, and performing the ultra-high-speed laser cladding of the bottom layer from inside to outside to obtain the brake disc having the bottom layer;
the ultra-high-speed laser cladding of the hard surface layer comprises: performing, from outside to inside, the ultra-high-speed laser cladding of the hard surface layer on the brake disc having the bottom layer to obtain the brake disc having the surface ultra-high-speed laser cladded wear-resistant and corrosion-resistant coating;
∠1 remains unchanged during the ultra-high-speed laser cladding of the bottom layer and the ultra-high-speed laser cladding of the hard surface layer;
in the ultra-high-speed laser cladding of the bottom layer, an initial rotation speed of the brake disc to be cladded meets:
$${W}_{1} = V \cdot {D}_{1}^{- 1} / π ;$$
in the ultra-high-speed laser cladding of the bottom layer, an initial movement speed of the cladding head meets:
$${M}_{1} = L ( 1 - η ) V \cdot {D}_{1}^{- 1} / π ;$$
during the ultra-high-speed laser cladding of the bottom layer, a rotation speed of the brake disc to be cladded is gradually decreased and meets:
$${W}_{1}^{′} = [ - {D}_{1} + \sqrt{{D}_{1}^{2} + 8 L ( 1 - η ) V {t}_{1} / π} ] / 4 L ( 1 - η ) {t}_{1} ;$$
during the ultra-high-speed laser cladding of the bottom layer, a movement speed of the cladding head is gradually decreased and meets:
$${M}_{1}^{′} = [ - {D}_{1} + \sqrt{{D}_{1}^{2} + 8 L ( 1 - η ) V {t}_{1} / π} ] / 4 {t}_{1} ;$$
in the ultra-high-speed laser cladding of the hard surface layer, an initial rotation speed of the brake disc having the bottom layer meets:
$${W}_{2} = V \cdot {D}_{2}^{- 1} / π ;$$
in the ultra-high-speed laser cladding of the hard surface layer, an initial movement speed of the cladding head meets:
$${M}_{2} = L ( 1 - η ) V \cdot {D}_{2}^{- 1} / π ;$$
during the ultra-high-speed laser cladding of the hard surface layer, a rotation speed of the brake disc having the bottom layer is gradually increased and meets:
$${W}_{2}^{′} = [ {D}_{2} + \sqrt{{D}_{{2}^{-}}^{2} 8 L ( 1 - η ) V {t}_{2} / π} ] / 4 L ( 1 - η ) {t}_{2} ;$$
and
during the ultra-high-speed laser cladding of the hard surface layer, a movement speed of the cladding head is gradually increased and meets:
$${M}_{2}^{′} = [ {D}_{2} + \sqrt{{D}_{{2}^{-}}^{2} 8 L ( 1 - η ) V {t}_{2} / π} ] / 4 {t}_{2} ,$$
wherein W₁ refers to the initial rotation speed of the brake disc to be cladded in preparation of the brake disc having the bottom layer, in unit of r/min; W₁′ refers to a real-time rotation speed during the preparation of the brake disc having the bottom layer, in unit of r/min; W₂ refers to the initial rotation speed of the brake disc having the bottom layer in preparation of the brake disc having the surface ultra-high-speed laser cladded wear-resistant and corrosion-resistant coating, in unit of r/min; W₂′ refers to a real-time rotation speed during the preparation of the brake disc having the surface ultra-high-speed laser cladded wear-resistant and corrosion-resistant coating, in unit of r/min; M₁ refers to the initial movement speed of the cladding head in the ultra-high-speed laser cladding of the bottom layer, in unit of m/min; M₁′ refers to the movement speed of the cladding head during the ultra-high-speed laser cladding of the bottom layer, in unit of m/min; M₂ refers to the initial movement speed of the cladding head in the ultra-high-speed laser cladding of the hard surface layer, in unit of m/min; M₂′ refers to the movement speed of the cladding head during the ultra-high-speed laser cladding of the hard surface layer, in unit of m/min; V refers to a linear speed, in unit of m/min; L refers to a laser spot diameter, in unit of m; η refers to an overlap rate, D₁ refers to an inner diameter of the brake disc, in unit of m; D₂ refers to an outer diameter of the brake disc, in unit of m; and t₁ and t₂ respectively refer to a cladding time of the ultra-high-speed laser cladding of the bottom layer or a cladding time of the ultra-high-speed laser cladding of the hard surface layer, in unit of min.

2. The method for preparing the brake disc having the surface ultra-high-speed laser cladded wear-resistant and corrosion-resistant coating as claimed in claim 1, wherein the pretreatment comprises:
removing oil stains from a surface of the brake disc by using alcohol and/or acetone to obtain the brake disc to be cladded.

3. The method for preparing the brake disc having the surface ultra-high-speed laser cladded wear-resistant and corrosion-resistant coating as claimed in claim 1, wherein raw materials of the bottom layer prepared by the ultra-high-speed laser cladding of the bottom layer comprise 316L stainless steel.

4. The method for preparing the brake disc having the surface ultra-high-speed laser cladded wear-resistant and corrosion-resistant coating as claimed in claim 1, wherein raw materials of the hard surface layer prepared by the ultra-high-speed laser cladding of the hard surface layer comprise an iron-based alloy and hard particles.

5. The method for preparing the brake disc having the surface ultra-high-speed laser cladded wear-resistant and corrosion-resistant coating as claimed in claim 4, wherein the iron-based alloy, based on a total mass being 100%, comprises:
less than 0.02 wt % of C, 16 wt %-18 wt % of Cr, 11 wt %-13 wt % of Ni, 2 wt %-3 wt % of Mo, 0.5 wt %-1 wt % of Si, 0.1 wt %-0.5 wt % of Mn, and Fe as a balance.

6. The method for preparing the brake disc having the surface ultra-high-speed laser cladded wear-resistant and corrosion-resistant coating as claimed in claim 4, wherein the hard particles comprise one or more selected from the group consisting of tungsten carbide, titanium carbide, chromium carbide, and silicon carbide.

7. The method for preparing the brake disc having the surface ultra-high-speed laser cladded wear-resistant and corrosion-resistant coating as claimed in claim 4, wherein at least one of conditions as follows is met:
A. a particle size of the iron-based alloy and/or the hard particles is in a range of 15 μm to 53 μm; and
B. a mass content of the hard particles in the hard surface layer is in a range of 20 wt % to 50 wt %.

8. The method for preparing the brake disc having the surface ultra-high-speed laser cladded wear-resistant and corrosion-resistant coating as claimed in claim 1, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

9-10. (canceled)

11. The method for preparing the brake disc having the surface ultra-high-speed laser cladded wear-resistant and corrosion-resistant coating as claimed in claim 2, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

12. The method for preparing the brake disc having the surface ultra-high-speed laser cladded wear-resistant and corrosion-resistant coating as claimed in claim 3, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

13. The method for preparing the brake disc having the surface ultra-high-speed laser cladded wear-resistant and corrosion-resistant coating as claimed in claim 4, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

14. The method for preparing the brake disc having the surface ultra-high-speed laser cladded wear-resistant and corrosion-resistant coating as claimed in claim 5, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

15. The method for preparing the brake disc having the surface ultra-high-speed laser cladded wear-resistant and corrosion-resistant coating as claimed in claim 6, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.

16. The method for preparing the brake disc having the surface ultra-high-speed laser cladded wear-resistant and corrosion-resistant coating as claimed in claim 7, wherein at least one of conditions as follows is met:
A. the linear speed is in a range of 100 m/min to 200 m/min;
B. the laser spot diameter is in a range of 3 mm to 5 mm;
C. the overlap rate is in a range of 70% to 90%;
D. the ultra-high-speed laser cladding of the bottom layer and the ultra-high-speed laser cladding of the hard surface layer are conducted at a power of 6000 W to 12000 W; and
E. a powder feed rate of the cladding head is in a range of 2 g/s to 5 g/s.
